(19) United States
(12) Patent Application Publication
(10) Pub. No.: US 2022/0404269 A1
(43) Pub. Date: Dec. 22, 2022

(54) Automated System and Method for Single Dye Volumetric Verification and Calibration of Automated Liquid Handling and Pipetting Systems

(71) Applicant: Petar Stojadinovic, Sacramento, CA (US)

(72) Inventor: Petar Stojadinovic, Sacramento, CA (US)

(21) Appl. No.: 17/589,878

(22) Filed: Jan. 31, 2022

Related U.S. Application Data
(60) Provisional application No. 63/143,804, filed on Jan. 30, 2021.

(51) Int. Cl. G01N 21/31; G01N 35/00

(52) U.S. Cl. CPC G01N 21/31; G01N 35/00693; G01N 35/00663; G01N 2035/00673

(57) ABSTRACT

The method presented here is used to determine the volume dispensed by any liquid handling device (automated or manual) . A reference curve is first generated by spectroscopically reading a fixed-volume set of known, variable-concentration derivatives of a single dye. During testing the liquid handling device dispenses a yet undetermined volume of known-concentration dye into a known volume of diluent which results in a new dye concentration (resultant concentration). The absorbance of the resultant concentration is then compared to the absorbance vs concentration relationship of the earlier generated reference curve to determine the volume of dye (hence volume) dispensed by the liquid handling device. This method is an alternative to the dual dye and gravimetric volume verification methodologies. It considers and corrects for the uncertainties found in a traditional single dye approach as stated in the IWA-15 ISO standard. The system and method is distributed in bundled kits including but not limited to standardized labware, a calibrated reference pipette, a proprietary Validation Reference Plate (VRP) which automates reference curve generation, a spectrophotometer calibration plate for NIST Traceability, an environmental monitor, reference reagents, test reagents, an apparatus for quality assurance and control during manufacturing, and proprietary software for data analysis and reporting.

### CROSS-REFERENCE TO RELATED APPLICATIONS

This application claims the benefit of U.S. provisional application No. 63/143,804, filed 30 Jan. 2021, which is hereby incorporated by reference as though fully set forth herein.

### BACKGROUND

### a. Field

The present disclosure systems and methods for determining the inaccuracy and imprecision of an automated or manual liquid dispenser. This disclosure further relates to systems and methods that use laboratory automation equipment in the processing of microtiter-plate based assays. The method permits diagnostic or investigative instrumentation using absorbance type measurements and laboratory robots in the analysis of samples to verify the inaccuracy and imprecision of the dispensing pipette or device(s) of the robot. This method finds particular use in diagnostic instruments and research-based instruments in the analysis of samples used in Clinical, Forensic, RNA Manufacturing, Research, Pharmaceutical, Biotechnology, Academic, and other labs that use instrumentation for transferring liquid. In one example, the systems and methods have application in COVID testing procedures, such as with use of PCR and Master mix kits.

### b. Background

Microtiter plates have become common labware for containment, transfer, and experimentation involving liquid-based assays. Well-performing liquid transfer instrumentation can be important for bio-chemical sciences. Determination of the inaccuracy and imprecision of dispenses through cost effective and efficient diagnostic measurement tests help maintain proper operation of instrumentation in producing reliable output.

Users of automated liquid handling systems can be acutely aware of the impact of volume transfer accuracy and precision on data quality. Further, some technologists are uneasy about how to perform volume verification, due to what they feel is the lack of an ideal solution. Users and the literature report that single-dye home brews can lead to errors and inconsistencies, with results dependent on the technique of those creating the dye solutions. Some users also complain that the existing commercial dual-dye method is complicated and costly.

### BRIEF SUMMARY

In one embodiment, a solution is provided that provides reliable results and is affordable. For example, a modified single-dye method that considers and corrects for the uncertainties found in a traditional single dye approach as stated in the IWA-15 ISO standard is provided. Quality can be ensured, such as by manufacturing the dye solutions in a controlled and inspected environment.

Embodiments provided address all or a portion of steps involved in the diagnostic steps in testing reliability and repeatability of instrumentation that handles liquid dispenses and mixes; thereby systems and methods include, but are not limited to, the following.

A scanner adapted to improve quality control and assurance of manufactured reagents with a medical manufacturing process is provided in one embodiment. As an example, a scanner has application as a miniaturized reader on robot deck for UV or as absorbance readings. In one particular embodiment, a modified cartridge can be adapted to fit on a 96 well or 384 well plate to be as a universal validation or calibration plate of spectrophotometer plate readers.

Improved, stable, and sterilized single-dye test reagents can be adapted to be compatible with Aqueous, DMSO, alcohol, buffers, serum diluents, and may be customized. The aqueous dilution reagents have a density close to water making them very useful for PCR and qPCR testing kits. In one example, tests with Roche qPCR kits found spike volumes to have a linear one to one relationship with our reference curve and volumetric calibration performance curves.

Reliable and linear single dye reference reagents can also be provided. For example, such single dye reference reagents may be used to generate of a linear reference curve relating optical density to concentration, pathlength, and volume from reading absorbance from a calibrated spectrophotometer of a fixed path well volume dispensed into a microtiter plate calculating volume using Biers law.

In another embodiment, a defined universal calibration plate and steps of spectrophotometer are provided for NIST traceability and accurate readings.

In another embodiment, methods for spectrophotometer and automated liquid handler with sample validated liquid classes are provided.

In yet another embodiment, a reference pipette with disposable (e.g., 200 uL) pipette tips for accurate and precise dispense of reference dyes at fixed pathlength in generation of a reference curve is provided.

In one particular embodiment, a plurality of reference dyes (e.g., four reference dyes (Alpha, Beta, Gamma, Omega)) are used to efficiently, effectively, and easily generate a single standard curve (or reference curve) by manually pipetting four 200 ul dispenses with a fixed single channel P200 or 8-channel multi-pipette in 3-replicates into a 96 well plate or using a fixed P50 single or 8-channel pipette into a 384 well. The 4-point reference curve spans nanoliter to milliliter volume verification testing relating volume delivery to optical density analyzed from the output from a spectrophotometer.

A fabricated Universal Validation Reference Plate (VRP) that operates on most UV-VIS spectrophotometers is also provided. A VRP automates the generation of the single standard curve (or reference curve). This eliminates the labor and potential operator error in generating a single standard curve (or reference curve) manually. A second embodiment of a VRP (sometimes referred to herein as a VRP Gen2) is another fabricated design that works on most 96/384 plate absorbance spectrophotometers. Yet another embodiment (referred to herein as a VRP Gen3 design) is fabricated specifically for the narrow opening of the Byonoy Absorbance 96 mini-plate reader with Absorbance 96 software to operate the mini-plate reader that is distributed with QC kits.

In various embodiments, associated standardized labware to contain liquids (reference dye troughs, microtiter plates, reservoirs for diluents and reagents) are also provided.

The embodiments may also include one or more of a spectrophotometer, a manual or automated pipetting system, and/or optimized liquid class settings and parameters.

In one embodiments, Software handling spreadsheets are provided for data gathering, such as compliant with labs that do not allow internet in the lab, and simple cloud based NIST secure compliant data management and storage facility for data analysis, reporting, and tracking of results. GLHTracker Cloud and GLHTracker Desktop software software for data analysis and reporting.

Various embodiments, such as QC kits, may also be provided with and/or distributed with software, such as the BioTX WellAware software (includes most popular protocols like Elisa, PCR, etc. and used to track and guide pipette actions by users with visual and audio indicators), tablet, and accessories to support manual pipetting processes, protocol development, and testing of manual pipettes.

Various embodiments may further include coding, such as barcoding for tracking and registering reagents, equipment, and labware used.

Environmental monitoring, such as through Wi-Fi Environmental Data Logger device that may be ordered to automatically data capture and stream to software, such as GLHTracker software, various environmental factors such as Temperature and Humidity to help implore possible corrections from evaporation.

Embodiments may also include a preventative maintenance kit, such as with all manufactured parts to perform service maintenance and calibration.

Embodiments may also include one or more other components, such as a UV scanner to detect any contaminants during manufacturing.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an example embodiment of a contaminant detection UV scanner. In this embodiment, the diagram shows a Ultra-Violet (UV) light source that shines through a vial placed in a vial holder. A signal is detected on a recorder displayed. A pre-manufacturing sample (e.g., a pillow pack sample) signal is compared with a post-manufacturing signal and flagged as passed if the signals are the same/within a specified manufacturing tolerance or failed if outside the tolerance. In one embodiment, for example, a device supports a single vial although other arrangements are contemplated. The light source may be powered, such as by battery operation or powered with an AC power supply. A multiple-vial device can be built for higher throughput.

FIG. 2 illustrates an embodiment including four reference dyes dispensed with calibrated and fixed volume GLH Pipettes from troughs in triplicate into a 96 well with single channel or 8-channels.

FIG. 3 shows a depiction of an example material illustration, such as in a QC Lite Kit.

FIG. 4 shows example method steps based on an example of a 96-Channel, 20 uL, fixed-tip head, 2, 10, 20 uL test (test samples in triplicate). An alternative method for a 384-channel can include the same steps however a total well volume transfer may amount to either 25 ul or 100 uls and is configurable. In one example, the method includes four steps involved in conducting a test. 1. Generating a reference curve from 4 reference packs Alpha, Beta, Gamma, and Omega 2. Preparation of a test with micro or bulk and a diluent with an automated dispenser combined in an output plate 3. Mixing the reagent and diluent with an orbital shaker at 600 rpm for 2 minutes 4. Spreadsheet for data gathering in lab and data analysis and customized reporting in cloud based GLH tracker software.

FIG. 5 is an illustration of an example liquid handling robot effecting the transfer of samples and reagents to microtiter plates for reaction and measurement.

FIG. 6 illustrates an example embodiment of a kit in which items in an example kit (QC Cal Kit Lite) and additional items that may be included in the kit or may be supplied by a user in performing a diagnostic test.

FIG. 7 is an illustration showing an example of how a signal of dispense can be converted to a volume by use of a reference curve with subtraction of noise read at a specific wavelength.

FIG. 8 is an illustration showing a process of testing various volumes from reservoirs and destination microtiter plate used on robot deck, read with a reader, and test dye and diluent volumes dispensed.

FIG. 9 illustrates an embodiment showing an example placement of a Universal Validation Reference Plate (VRP) into a typical plate reader for validation.

FIG. 10 shows a front view of scan area on an example fabricated VRP Plate.

FIG. 11 illustrates a front and a side view of an example VRP (referred to as a VRP Generation 2) that is designed for any absorbance spectrophotometer besides the Byonoy Absorbance 96 plate mini-reader. The diagram shows the locations of the reference and water reagent cartridge side openings for loading with a top view scanning holes that light passes through the cartridge from top to bottom from emitter to detector in the plate reader (spectrophotometer).

FIG. 12 illustrates another example Universal Validation Reference Plate Generation 3 (VRP Gen3) for the Byonoy Absorbance 96 plate mini-reader. In this embodiment, the design also works on the same plate readers and Generation 2 design. However, Generation 2 design cannot fit into the narrow opening of the Absorbance 96 plate mini-reader hence required a new generation design into Generation 3.

FIGS. 13 through 15 illustrate views of example validation reference plates.

### DETAILED DESCRIPTION

Methods for Modified Single Dye Application of Controlled Parameters

In one embodiment, use of VRP with Absorbance 96 (Personalized Mini-Plate Reader) & other readers— an automated standard curve generation is provided without operator error (or reduced operator error), reduced/minimal labor, and maintained control of parameters such as minimized evaporation of liquid delivered, maintained pathlength independence during standard curve generation and pathlength corrected sample volumes during performance testing to reflect the actual volume delivered to a pathlength independent standard curve. VRP was tested with digital syringe, fixed volume, & multi-channel pipettes in 96/384 wells.

Use of GLH single-dye absorbance assay in PCR—was useful during IQ/OQ/PQ and optimized routine testing conducted pre-PCR Covid-19 testing to verify pipette performance. Multi-volume (1-3 μL, 10 μL, 200-275 μL) validated on Agilent Bravo-96 & Tecan Genesis 8-Channel under typical laboratory conditions (14-23° C.)/(44-67% RH).

Use of GLH single-dye absorbance assay in qPCR-helped create a relationship of serially diluted concentrations to volume needed for qPCR reactions to operate. It was discovered that proper GLH volumes correlated well with spike volumes and GLH guided the volume needed for improved quality of qPCR results.

An example method for a 96 well plate with a total well volume of 200 ul dispense is provided, however the same method may be performed on other size well plates, such as a 384 well plate for total well volume of 50 ul dispense.

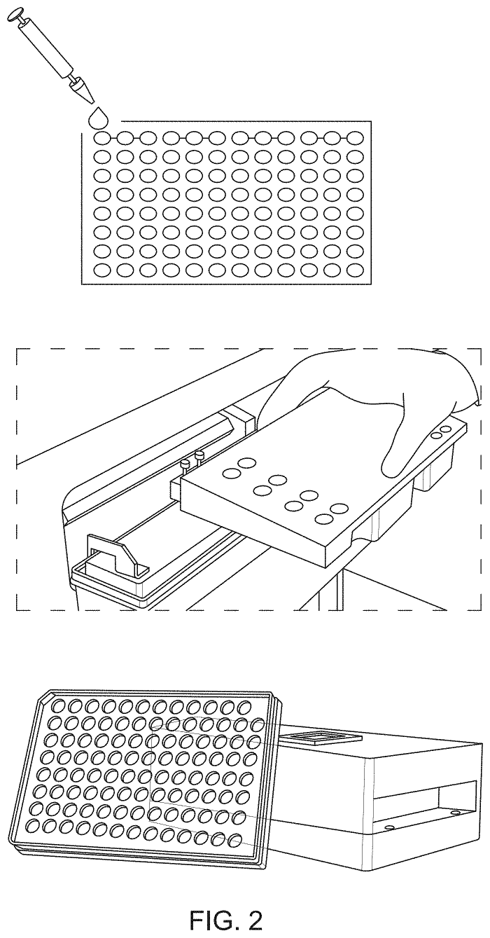

A first-generation method that is typically preferred in field testing under user control in non-ambient or ambient conditions was used: The method was the reference curve was generated first using a reliable manual handheld pipette method. Four reference dyes were dispensed with calibrated and fixed volume GLH Pipettes from troughs in triplicate into a 96 well with single channel or 8-channels as illustrated on the top and shown in FIG. 2.

Method of VRP and Mini-Plate Reader Use

A second-generation method used under manufacturing specification was the following: A reference curve was pre-generated in a manufactured GLH universal Validation Reference Plate abbreviated as VRP. The method shown on the right (FIG. 2) did not involve pipetting or effort on the user just to scan the plate on a reader thus minimizing/reducing any preparation or user error. The VRP was drop tested from a 6-foot height on to a tile floor and shipped FedEx in a regular envelope by ground and air and results after 6 months were identical to pre-assembly results matching results generated by hand with a digital syringe in triplicate in a 96 well plate scanned with a Biotek Uquant reader.

Overview of Example Devices

Embodiments of reagents and supported products provide users the ability to self-verify, calibrate, validate, and maintain their automated pipetting systems. In one embodiment, for example, product uniqueness includes modified reagents, kit design, consumables, software, methods, and protocols combined into a cost effective and efficient kit that alleviates “guess” work from conducting volume verification and calibration of Automated Pipetting and Automated Liquid Handling instruments. Embodiments can be packaged and sold in product kits that are based on full channel head tests, microtiter plate formats, diluents, and application to a suitable dispense technology that may have a slightly different design for different user needs. There are two types of kits lite kits and kits in cases. In one embodiment, a difference between kits (e.g., the QC Kit and QC Kit Lite) is one kit (e.g., the QC Kit) may include a yearly subscription which supplies all consumables, full reagent reordering, all accessories, equipment (environmental sensor, mini-reader, tablet), software (GLHTracker, WellAware, Mini-reader software, and Robot Methods), and full support. On the other hand, to offer a lower price point the other kit (e.g., a QC Kit Lite) may include the GLHTracker software, VRP plate, reference dyes, test dyes, labware just for a full head test, and partial support. This is also used to provide a footprint cost of calibration and verification that all users can identify with. The lowest price point that also may be included with purchase of labware such as disposable tips and plates is the VnV kit will only comes with test regents and GLHTracker to provide quick qualitative precision testing. The lite kits exist as single use full channel head testing of a liquid handler such as for a 96 channel or a 384-channel head. QC Kit Lite 96 is suitable for most pipetting dispense technologies into a 96 well microtiter plate of a 96-channel head. The QC Kit Lite 384 is also suitable for most pipetting dispense technologies into a 384 well microtiter plate test of a 96 channel or a 384-channel head. All lite kits can also test lower channels like 4, 8, 16 etc. in 96 or 384 well format. Other higher density channel lite kits may be produced like for 1536 and support lower volume dispenses in nanoliter or picoliter depending on the sensitivity of the spectrophotometer.

For higher quantities of reagents and labware bundles designed in cases we have the QC, Service Cal, and VnV kits. QC and Service Cal kits use reference reagents. Each kit in a flight case varies by what is included. The QC Kit comes with test reagents, reference dyes, and reference pipette with reference troughs, diluent and reagent reservoirs, and cases of microtitter plates for many full head 96 or 384 channel tests. The Service Cal kit is essentially the QC kit but includes service support, environmental monitoring with WIFI data capture of temperature and humidity, a spectrophotometer reader validation/calibration test plate if available for that model of reader, and a tablet for a service technician to use for recording data gathering in the field. The VnV kit or Volume Verification kit meant for qualitative and quick % CV testing includes software analysis and reporting of % CV and test reagents to generate a optional manual standard curve and perform channel tests to verify disposable tips, labware, and robot are functional. All these kits come in specially designed enclosed flight cases for travel to sites and safe storage of labware and reagents.

Tartrazine has an industry wide acceptance as defined in ISO standard IWA-15. However, it suffers from uncertainty conditions that the various embodiment provided herein improve in the reagents manufactured and process. The provided devices and methods have hown that uncertainties such as well to well, plate to plate, and evaporation have minimal effect on the success of the test.

System Operation

In one embodiment, a kit, such as a QC Cal Kit Lite, is designed to be used with either a 96 or 384-channel automated liquid hander (ALH) or automated liquid handling system (ALHS) to measure the volume delivered. This method is compatible with most common absorbance microplate readers, and the optical density readings generated.

In this method, a single REFERENCE PLATE is generated, which is read by a calibrated absorbance microplate reader, to generate an output file, such as in an accessible format such as an MS Excel format. The data can be copied and pasted into a provided template, which the Kit's Cloud-based software uses (behind the scenes) to essentially create an internal REFERENCE CURVE (linear regression curve) which associates known concentrations of REFERENCE DYES (liquid volumes) to the optical densities generated by a specific plate reader, in a lab, under the lab's typical environmental conditions (temperature and pressure). Reference data becomes internal data only—the user is not exposed to the hypothetical “reference curve” or the data generated. This “reference data” is used by the software, to provide the actual volumes your 96/384-channel pipetting system is transferring.

A reference plate is used each time a 96-channel or 384-channel pipetting head is tested or optionally and more conveniently doing a 10-20 second scan of the VRP plate. If multiple kits are used to test multiple pipetting heads over a short period (couple hours), with stable environmental conditions, a single reference plate may be used for all TEST PLATES.

Optical density is converted to volume readings for a user's pipetting head test samples. The QC Cal Kit Lite desktop that comes on a tablet or cloud-based software (performs the necessary calculations for a user, by using the Beer-Lambert Law (the linear relationship between absorbance and concentration of an absorbing species), and provides corrective calibration recommendations based on desired criteria of operational performance (% imprecision and % inaccuracy criteria for passing performance). The calibration recommendations may be implemented by adjusting a liquid handler's liquid class software settings. Retesting can be performed following any changes to the liquid handler's liquid class software settings. (In one embodiment, each kit is designed to test a single pipetting head, so another kit or additional, a la carte SAMPLE DYE would be used for retesting.)

In one embodiment, the performance of this kit can be improved when using a calibrated manual pipette, a calibrated, absorbance microplate reader and high-quality microplates with lids, in a controlled environment

In one embodiment, the QC Cal Kit Lite is made up of (2) two dye sets. Each set has four different concentrations of Tartrazine-dye in diluent (water in the standard kit). The first dye set is called the REFERENCE DYE SET. Each of the four-dye concentration (levels) is packed in a convenient one-time use, pillow-pack.

| | |
|---|---|
| REFERENCE DYE ALPHA | (15 mL) |
| REFERENCE DYE BETA | (15 mL) |
| REFERENCE DYE GAMMA | (15 mL) |
| REFERENCE DYTE OMEGA | (15 mL) |

In this embodiment, the entire contents of each the 4-REFERENCE DYE Pillow-packs is poured by hand, into its own reagent TROUGH and a calibrated high precision/high accuracy manual pipette is used to transfer each solution, to the “Reference Microplate. In a 96-Channel Kit, for example, 200 uL Transfers to Test Plate (in triplicate) for each of 4-levels. In a 384-Channel Kit, for example, 50 uL Transfers to Test Plate (in triplicate) for each of 4-levels. The REFERENCE PLATE becomes the kit's “gold standard.” It contains highly precise/highly accurate, known test dye volumes associated with specific O.D.'s which a plate reader generates (under the same environmental conditions and using the same plates, used for your test samples).

The second dye set is called the TEST SAMPLE DYE SET. Each of the four-dye concentration (levels) is also packed in convenient one-time use, pillow-packs.

| | |
|---|---|
| SAMPLE DYE NANO | (30 mL) |
| SAMPLE DYE MICRO | (30 mL) |
| SAMPLE DYE BULK | (30 mL) |
| SAMPLE DYE LARGE | (100 mL) |

This dye set uses the same, single dye (Tartrazine) but in different concentrations than the REFERENCE DYE SET. The dye concentration at each level is designed to (ideally) create a linear regression curve, but at an expanded choice of dilution volumes, for various test volumes using a 96 or 384-channel head.

Example Method Detail

QC Cal Kit Lite usage example: (Objective: Test a 96-Channel, 20 uL, fixed-tip head at 2, 10, 20 uL test dispenses.)

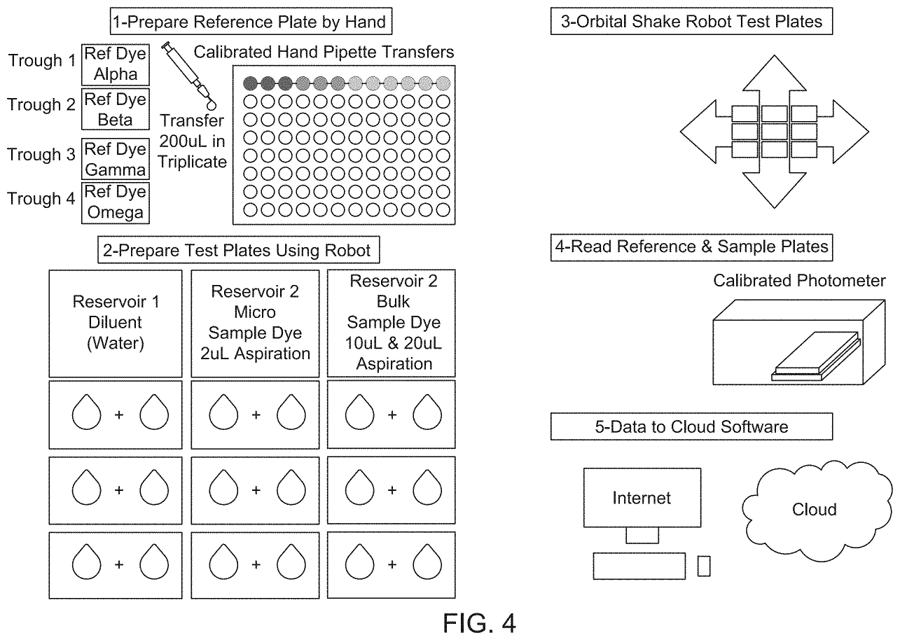

FIG. 4 shows an example method to Prepare Reference Plate by Hand. Function of the REFERENCE PLATE: When the reference plate has been created according to the instructions in this method manual, it provides traceable volume verification for the subsequent TEST PLATES. A reference plate is generated, once per testing session. The following are step by step instructions for generating a reference plate by dispensing a fixed volume of 4-concentrations of REFERENCE DYE into a single row, of (1) one microplate, in triplicate. The output of this step is a single microplate, with a single row of dye solutions. Each of the 4-REFERENCE DYE concentrations is dispensed in triplicate. Total Hand Pipetting: 12 Wells. In this embodiment, when testing a 96-Channel head, a 200 uL hand pipette is used, and 200 uL dye solution is pipetted to all REFERENCE PLATE wells. When testing a 384-Channel head, a 50 uL hand pipette is used, and 50 uL dye solution is pipetted to all REFERENCE PLATE wells.

Usage Example: (Objective: Test a 96-Channel, 20 uL, fixed-tip head at 2, 10, 20 uL test dispenses).

1.Ensure all instruments and supplies are at room temperature and your setup is not in direct sunlight.

2.Transfer 100% of each REFERENCE DYE provided (15 mL), into its own REAGENT TROUGH (provided).

3.Using a high precision/high accuracy CALIBRATED MANUAL HAND PIPETTE (included in full kit) or your own high precision/high accuracy, traceable pipette), transfer 200 uL of each REF DYE from its trough to its appropriate location within the REFERENCE PLATE X3 (triplicates 1-2-3). In one example, the reference plate is be a high quality, clear bottom, polystyrene microplate with lid.

4.Upon completing the plate, immediately place the lid on the plate (to reduce evaporation) and set aside for plate reading along with the TEST PLATES prepared next.

FIG. 4 further shows an example method using a robot to prepare test plates.

In this embodiment, the method includes identifying TEST DYE solutions and dilution volumes. The method further includes filing a diluent reservoir with distilled water (e.g., HLPC Grade, minimum 30 uL). Test reservoirs are also filled (e.g., Reservoirs 2 and 3) as shown in FIG. 4. An automated dilution operation is provided. Cover plates are then prepared for reading in another operation.

Dilutions on the test plates are mixed in another operation, such as to provide uniform optical density, and one or more references may be read after the mixing operation. Reference and sample plates are read. In one embodiment, a calibrated absorbance plate reader is used to read the plates at one or more predetermined wavelengths. Plate lids may be removed during the reading of the plates. In one embodiment, for example the plates are read at the following wavelengths: 425 nm Signal and 625 nm Noise. In one embodiment, for example, a Molecular Devices SpectraMax Absorbance Microplate Reader using SoftMax Pro software may be used to read an entire 96 well microplate, however any reader and associated software may be used.

In one embodiment, using a PC with access to the Internet, access may be made to a Cloud Software (e.g., using a 30-day access code included with reagents). Once logged into the software, the software may perform calculations for a user. The user may further use an Excel spreadsheet with data ready to input (e.g., copy and paste) into the cloud-based software's own version of this spreadsheet/table.

GLHTracker software—cloud based NIST based tracking, documenting, and reporting software can be provided to statistically processes results and provides graphical charted and heat map based reporting that may integrate with various third party reporting software such as Microsoft Sql Server, Power Builder, and Cognos. Its building reporting secure data exchange mechanism is JSON. Versions of the software are desktop and cloud based. It enabled tracking of settings for methods and experimental qPCR results. It also provides GLH Quick Statistical analysis with PQ charting and run history and provides secure JSON integration of third-party reporting. In one embodiment, GLHtracker Desktop software is an Excel executable that is secured and licensed to individual users by computer ID or MAC address with excel templates in row wise or matrix reader output. It can integrate with the cloud version and other excel data science or analysis features. The GLHTracker Desktop may offer analysis and reporting for volume verification (VnV) and QC calibration.

The QC kit can also include software for operating the Absorbance 96 mini-reader. It may also include a tablet loaded with GLHtracker Desktop and WellAware. WellAware software from our partnership with BioTX helps eliminate Fillaphobia which is the persistent fear real or imagined, in a lab of accidentally or distractedly or negligently pipetting or placing a sample into the wrong well of a microplate that leads to a compelling desire to avoid all pipetting. WellAware is a pipette navigation system that reduces ergonomic stress by being controlled hands-free using the Light sensor, a touch-screen or foot switch. Its slate and tablet PCs can be adjusted to provide a stable and comfortable platform for pipetting with improving user confidence in protocol development, eliminates costly errors with visual and audio prompting, and tracks user pipetting actions. All pipetting steps and lab protocols are documented with time-stamped electronic Standard operating Procedures (eSOPs).

Data gathering from reader can be achieved through excel spreadsheets. Data analysis, calculations, and reporting is achieved by uploading the data gathering spreadsheet into GLH Tracker cloud software. A library of robot and reader methods are provided for various liquid handlers and readers to prepare users to conduct the diagnostic test for instrument control and operation.

GLHTracker in this embodiment is used for tracking all laboratory tests as experiments. Instrument control methods, equipment details, resources used during testing, and user access in compliance with 21, CFR part 11 is tracked for NIST traceability.

Instrument control files for Automation Liquid Handlers (ALHs) includes performance and liquid class settings for the liquid being handled (aspirated and dispensed) such as speed, acceleration, airgaps, delays, and more describing the how the aspiration and dispense will be performed or controlled. Similarly, reader control files of the spectrophotometer will define the wavelength and number reads performed. These control files are supplied to users and are unique to the process so no system to date has supplied users such control files for proper operation in testing volume delivery.

Spreadsheets are utilized for the labs that are not connected to the internet due to security concerns we offer spreadsheets that may be uploaded, such as via browser or webdav drag and drop.

Biotechcloud.org (BTC)—In one implementation, this is a Webdav product that enhances a cloud with the capabilities to refer, create and join groups and link to magento and word press for easy processing by GLHtracker. It provides drop space in the cloud to users to share documents, images, and so own for collaboration purposes. The BTC lets one use their LinkedIn account and integrate their document sharing with their LinkedIn account and post from drag and dropping their content into BTC and share with Facebook or LinkedIn. It is meant as a technology for collaboration.

Labregistry.org/.com is a portal enabling labs to place themselves on a map interface and offer them marketplace visibility and marketing space with integration into LinkedIn and Facebook.

Robot methods may be performed using any number of available robotic systems, such as but not limited to automated liquid handlers from one or more of the following: Beckman, Hamilton, Perkin Elmer, Agilent, Tecan, Scitech, Ependorf, Gilson, Cybio, Leap, Dynamic Devices, OpenTron, Nanodrop, Apricot, and others are possible that have robot methods or are being developed through our reproducibility study members and our existing user base.

Similarly, spectrophotometers, such as but not limited to the following may be used: Beckman, Biotek, Perkin Elmer, Tecan others are possible.

FIG. 4 shows an embodiment of a process diagram for an automated system. As shown, this embodiment of a method includes a test sample volume verification and a calibration process and calculations as shown. A reference curve (standard curve) process is provided as shown.

The attached APPENDIX is incorporated by reference herein in its entirety and for all it teaches and suggests as if fully set forth herein. Included in the APPENDIX are tables and Figures described herein showing various embodiments and details of the Systems, Devices, and Methods described herein.

In one embodiment, one or more kits support serial dilution for qPCR Setup. The kits include one or more reagents that have a density close to water and can be adapted to aid in assessing the serial dilution performance using established automated qPCR preparation method designed for ALHs on the market. NGS library samples of known concentration are serially diluted to a target dilution factor, then plated with qPCR master mix reagent before executing qPCR. Six standards of known concentration are also run to produce the needed standard curve for concentration determination. The kits are adapted to work with qPCR reagents that may be obtained through many quantification kits on the market such as the KAPA Biosystems KK4854 Library Quantification Kits and used according to the manufacturer's instructions. The GLH™ qPCR kits provide spectrophotometric correlation to work with dyes from the GLH™ QC Kit and is used as substitute samples during serial dilution preparation and diluted using the same qPCR setup method. Standard GLH™ QC™ volume verification is then performed using the GLH™ QC™ reference curve. This may be automated with use of the VRP plate and GLHTracker upgrades to include the calculations performed during qPCR.

Due to the unique nature of the dye used in various embodiments, it can work with many options of organic diluents and inorganic solvents. We can work with many types of diluents including: DMSO, various buffers, low viscosity and high viscosity liquids. For DMSO we provide a portable centrifuge allowing for small manageable bench top real estate or field work. Alcohols, glycerol, serum and other diluents have been tested to be feasible to manufacture.

We provide a modified single dye-based method that alleviates the uncertainties of the ISO IWA-15 Tartrazine single dye based standard. Our system removes/reduces guess work in testing and calibration of Automated Liquid Handling and Pipetting systems that users may experience with “home grown” or other type systems. The regents are FDA approved for human use, bio-safe, and biodegradable providing high specificity and applicability in characterizing unknowns. The system also provides only 4 reference points that are a linear combination across the entire volume range offering high performance, efficiency, and effectiveness in use. We currently use a single dye method but can support dual dye as well. We provide verified reagent dyes that in a wide dynamic range provide, highly resolved data, high repeatability, and linearity across the entire range of testing from nanoliters to a few liters. The dye volume range is limited to the signal to noise of the spectrophotometer used to read absorbance and volume calculated from the relationship of dye concentration and the reference curve generated from reference dyes.

A single dye system and method uses an FDA approved “red dye” reagent that contains as listed in our MSDS ingredients of Tartrazine, sodium benzoate, citric acid and other ingredients and preservatives close to a density and viscosity of water and a pH from 4 to 5 to maintain sterility. We dilute the dye with various diluents such as distilled water, DMSO, serums, PBS or other reagents that may be custom manufactured and mixed based on customer needs. We tune the concentration of the mixtures based on mathematical calculations for linearity in specific volume ranges using user required diluents to work on most off the shelf spectrophotometers.

Dual Dye reagents may include a mixture of red and blue dye and ratiometrically calculated to achieve pathlength independence. In one embodiment, for example, a blue dye contains Blue#1. Both dyes contain a disodium salt, sodium benzoate, citric acid and other ingredients and preservatives close to a density and viscosity of water and a pH below 5 to maintain sterility. The two dyes are combined and concentrations are mathematically mixed for linearity to perform well in specific volume ranges in a diluted blue dye. Our blue dye is serially diluted for specific optical density ranges to not saturate absorbance readings with sensitivity to detect pico liters.

In one embodiment, a system and method use NIST traceable calibrated scales for medically mixing the reagents by mass. We control quality (QC) the dye mixtures that get produced into multiple products packaged currently in pillow packs for performance and optimization. We use devices calibrated with ISO 17025 accompanied with serviced documentation following NIST standards involved in mixing, measuring, and controlling the quality of our reagents. Devices involved in manufacturing and utility include mass scales, UV readers, and spectrophotometers. Documentation is maintained in hard copy forms that are signed off and in PDF files stored in our document management system.

Red dye products can be adapted to have optimized signal to noise ratio at 425 nms and our Blue dye products have an optimized peak at 630 nms.

Another unique aspect of example dyes is when produced into our GLH references which are predetermined concentrations for specific volume deliveries is used for generating reference (standardized) calibration curves to convert optical density measurements from spectrophotometers to volume delivered with a pipette. Another uniqueness is a reference curve generated only once that spans all volume ranges of Nano, Micro, Bulk, and Large. References are utilized for nano and micro volume ranges because creating standardized curves with manual pipettes may be time consuming, unreliable, and irreproducible. In addition, reference curves at large volumes do not have the challenge as with creating standardized curves in 200 μL total well volumes for 96 well formats and 50 μL for 384 well formats having serial dilutions limited by microwell capacity that is well below 1 mL. Consequently, large volumes cannot maintain an absorbance reader pathlength within microwell capacities, so a special method is prepared with the reference curve to overcome the path length requirement. Also, tests are performed in multi-dispenses to maintain a pathlength at 200 uls for 96 and 50 uls for 384 that readers may have supported measurements.

An efficient cost-effective sterilization process is also provided that entails mixing proper amounts of sodium benzoate and citric acid to achieve an acidity (pH) that make the environment of the reagents unconducive for viral and bacterial growth and do not affect the pipette materials. The process has premixes produced for each pillow pack product type that is added in accurate weights into the mixtures prior to packaging the pillow packs. This method of sterilization is the most inexpensive process over other sterilization methods such as filtration and irradiation that allows us to maintain an economical price point.

No growth was observed for spores or molds confirmed with a smear test in a petri dish of two controls with and without bubbles in test medium for each volume range product type Large, Bulk, Micro, Nano, and reference curve type Alpha, Beta, Gamma, and Omega captured on an electronic microscope after growth incubation for 48 hours. Pillow packs with unsterilized mixes were discovered to develop spore and mold growth and were sent to a laboratory for analysis to identify types of growth that did not exhibit growth in sterilized pillow packs. In addition, we have manufactured in clear pillow packs providing visible proof to users of no growth products.

In one embodiment, the reagents are manufactured within an ISO Certified, FDA inspected medical reagent manufacturing facility. Volume verifications and Calibrations performed with Automation Trainer Reagent Kits, provide metrological traceability when used with a calibrated, NIST traceable plate reader, calibrated manual hand pipette and ISO 17025 calibration services. Reagent Kits use similar (and improved) methods, as those found in ISO IWA 15 “Specification and method for the determination of performance of automated liquid handling systems,” and have been tested in Clinical, Forensic, RNA Manufacturing, Research, Pharma, Biotech, Academic, and other labs. Cloud-based software is in NIST 800-53 Security Compliance.

FDA approved ingredient, single-dye reagents are safe, easy to use and available in pillow packs with a (1) one year shelf life. Original Reagent Kits, can be resupplied with ala carte pillow packs as required. Custom end-user kits and supplies are available to build your own-end-user test package, for the way you'd like to test your liquid handler. Quantity discounts available.

In one embodiment of a kit, beyond the reagents, methods and software supplied provide a turn-key solution, using proven methods, that is convenient to use and cost-effective.

Reagent Pillow Pack Contents: Tartrazine (also known as FD&C Yellow #5) is a synthetic lemon-yellow azo dye primarily used as a food coloring. (Although Pillow Packs are described as an example, other form factors for supplying reagents may be used). Tartrazine-based aqueous solutions in this embodiment can be made up of well characterized components which improve consistency and extend shelf-life. Each pillow-pack solution may contain the dye plus diluent, at different concentrations (optimized for this application).

Our single and dual dye manufacturing are unique through manufacturing the reagent dyes in diluents that users need which mimic their assays. Currently we manufacture aqueous and can manufacture DMSO and PBS diluents. However, are able to support diluents in many liquid classifications with varying viscosity and density. Our dye solutions in aqueous diluents are unique having a density and viscosity close to water that provide very efficient and effective qPCR quantification reactions.

Manufacturing quality control is achieved by first checking the UV results of the samples prior to being packaged into pillow packs. Then post manufacturing the pillow packs are opened and verified the same UV values match the pre-manufacturing UV results to confirm the same mixture was packed. Pillow packs are then tested with a spectrophotometer to ensure performance of the pillow packs with absorbance measurements and tested with specific operational volumes to pass the operational qualification of the manufactured products. The UV device supports a single UV light source to read a single vial at a time. We also have designed a multi-vial UV scanner QC that may be also placed on the deck of the robot to test volume delivery in real time workflows.

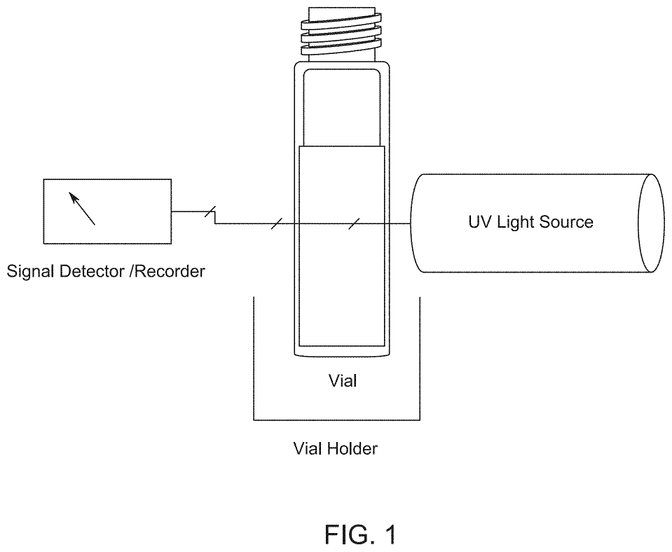

FIG. 1 shows an example contaminant detection UV scanner—The diagram shows a Ultra-Violet (UV) light source on the right that shines through a vial placed in a vial holder. The signal is detected on a recorder on the left side and displayed. The pre-manufacturing in pillow pack signal is compared with the post-manufacturing signal and flagged as passed if the signals are the same or failed with in specified manufacturing tolerances on the signal read if the signals are not the same.

This device only supports a single vial and is very robust from operator error and friendly use. The light source may be battery operated or powered with an AC power supply.

FIG. 1B shows replication of the single channel into multiple channels with multiple light sources, detectors, and recorders. However, the spacing is within the tolerance for an automated liquid handler gripper robot arm to place vials into the robot deck GLH Multi channel QC Reader Enclosure. In this embodiment, it can support for 4 to 8 channels. A multi array system can also be provided and miniaturize the light sources and detectors into an array to scan through a microwell of 96 or 384 well formats scanning from the top of the plate and detecting from the bottom of the plate.

Standardized Labware: Standardized and pretested labware may be provided such as troughs, reservoirs, microtiter plate types, and pipettes. We provided validated liquid classes and methods for the instrumentation.

Environmental Monitoring: The Cal Kit and QC kit may contain an environmental data logger equipped with wife designed to gather data, specifically ambient humidity and temperature in the experiment during testing. This unique feature allows users to monitor conditions in any environment, allowing for corrections based upon evaporation and vapor pressure to be accurately calculated for each use.

Data Analysis and Uniform Software Solutions: In various embodiments, software solutions can be provided to follow and support automated data analysis, management, LIMS, ELN, reporting integration with Cognos, Microsoft SQL Server, SAP, and Oracle reports. Software can also provide integration with asset management.

Quality Control and Manufacturing: In one implementation, a medical manufacturing process can be followed for all consumables and packaging. A process for quality control can be unique by use of a frequency independent device for concentration determination.

Training and Education: In addition, A training and educational platform for ISO standardization of IW15 can also be provided that provides trainings and certifications of users to become liquid handling technicians and service technicians with various levels of user proficiency. This training will save labs from legal fines and penalties from audits protecting them from being out of compliance or violation of regulations and preventing them from mistakes.

In one embodiment, a unique training methodology provides student learning and cuts corporate costs and time on students in class. The learning assesses student learning before and after a lessons and reinforces student learning during lecture and during lab hands on exercises. During lab exercises the students have a mentor monitoring how they perform the labs and are available to guide them when they are stuck. The students are rewarded points for every lab they do on their own and for every lab they can correctly troubleshoot and figure out on their own. They buy time using their points for help from the mentor. The total points after each exercise grants them rewards and a score for their grade to assess their level of learning. This learning methodology also saves time and cost of instructors because less time is needed on site and more time is given to remote monitoring with mentors. All that is needed really from an on-site instructor is to provide conceptual discussion.

Workflow Automation: Software may be adapted for workflow and a miniaturized deck top reader provided for complete automation with artificial intelligence for in process verification and calibration. The system includes a tiny robot deck top reader that is placed on the deck of any robot with integration add on methods that add reader capabilities to existing robot methods. In addition, we offer a neural net that will learn pattern of use and prevent the system from going out of calibration. The neural net system will pause the system if a volume verification is needed and will try to prompt the user to perform, or will work with a scheduler to perform, volume verification. The system can bring up a warning if the system needs to be tested or is out of calibration. It will record the number of warnings and actions performed out of compliance. If actions are performed out of compliance a risk level will be displayed showing the validity of data results based on risk level from robot actions performed during a state of noncompliance.

This may serve as a semaphore for managing robot compliance and preventative maintenance to protect organizational data integrity.

Case Design: In one implementation, a case may include the following:

Kit Contents in a Flight Case Design

Unique Novelty is in the process and standardized resources included for conducting tests.

There are currently 3 flight case designs—Service Cal Kit, QC Kit, and VnV Kit. Our kits may contain—
1. Case design
2. Consumable reagents in unique pillow pack format for testing and calibration use
3. Reference consumable reagents for standard curve generation
4. Software
   a. Robot methods for each vendor type instrument supported
      i. Liquid Classes and standardized parameter settings
   b. Data gathering Excel spreadsheets
      i. 96 , 384, and specific channel based spreadsheets
   c. Data Tracking and Reporting software
5. Documentation
   a. Protocols
   b. SOPs
   c. Process and Procedures
   d. User manuals
   e. Training materials
Other contents bundled
Existing products bundled for improving its uniqueness and efficacy—
   1. Labware consumables
   2. Accessories
See, e.g., FIG. ______ (APPENDIX).

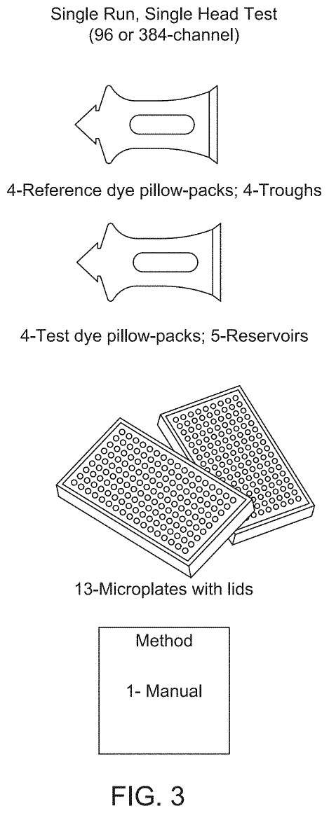

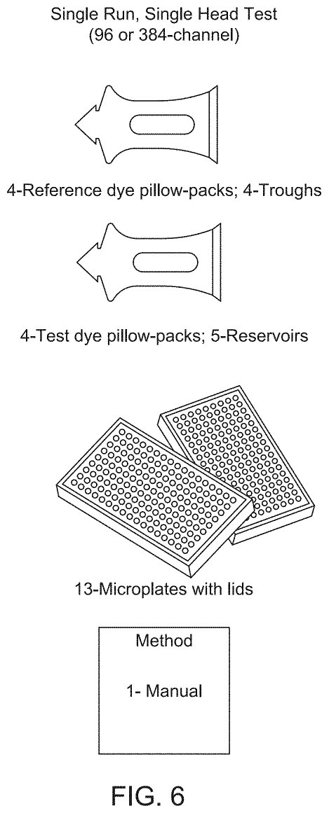

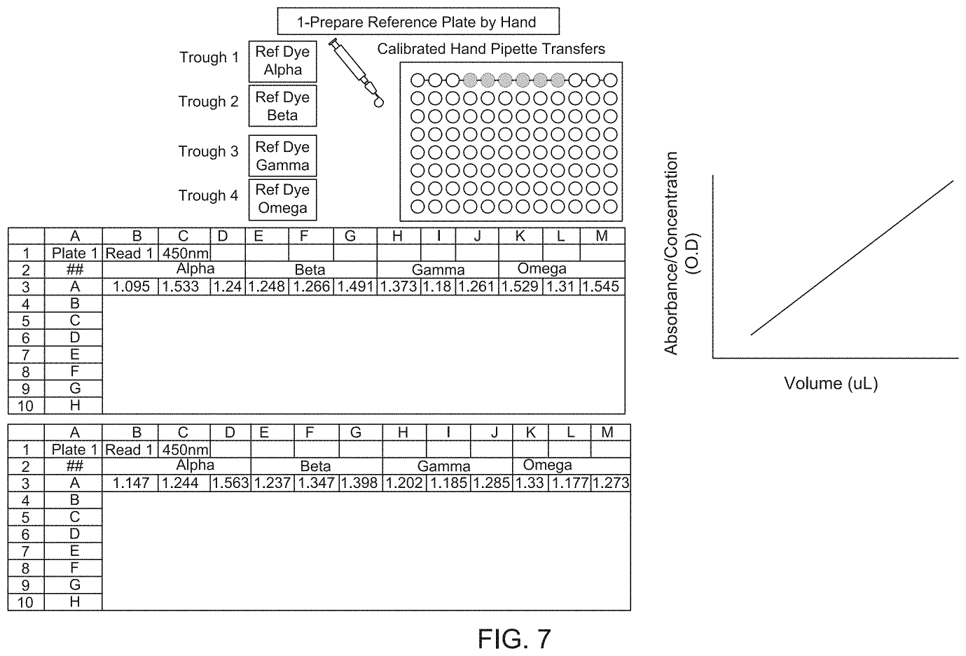

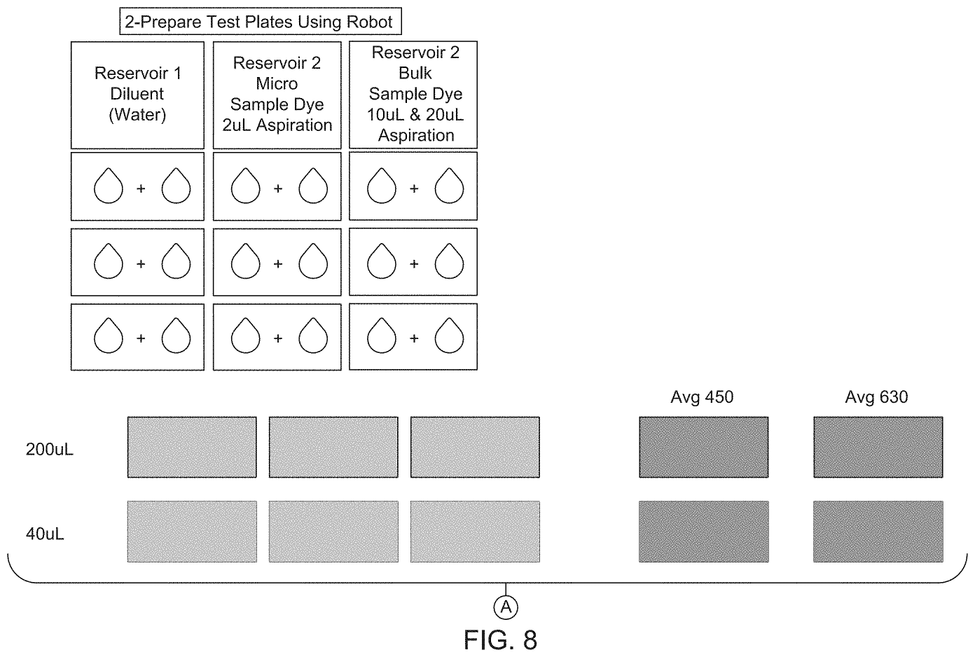

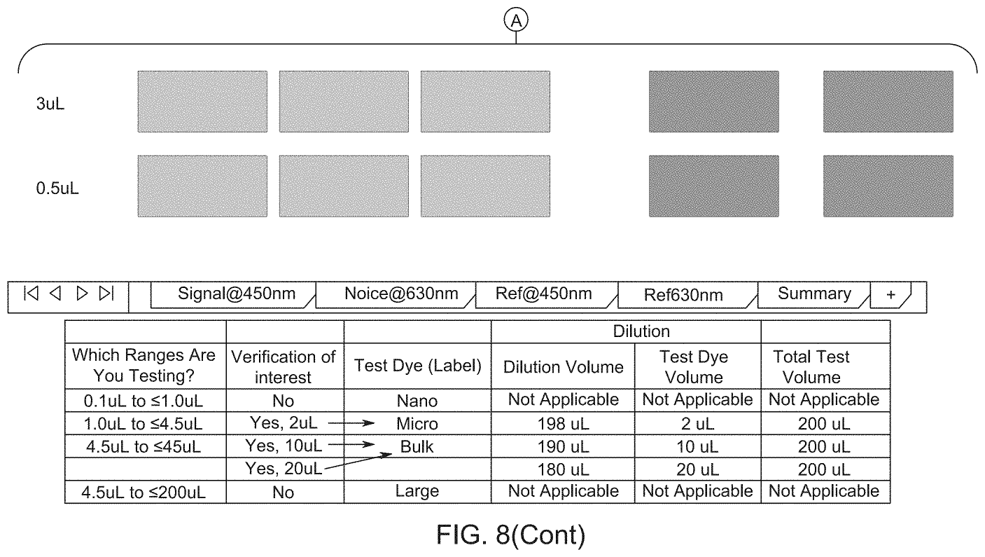

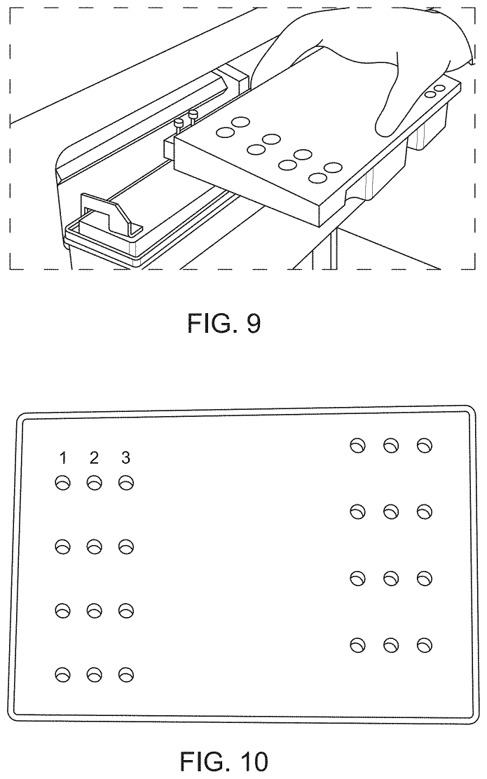

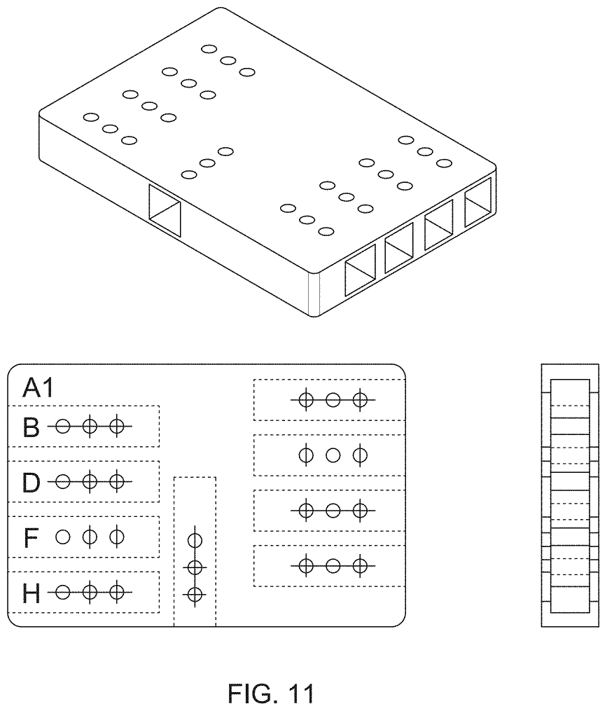

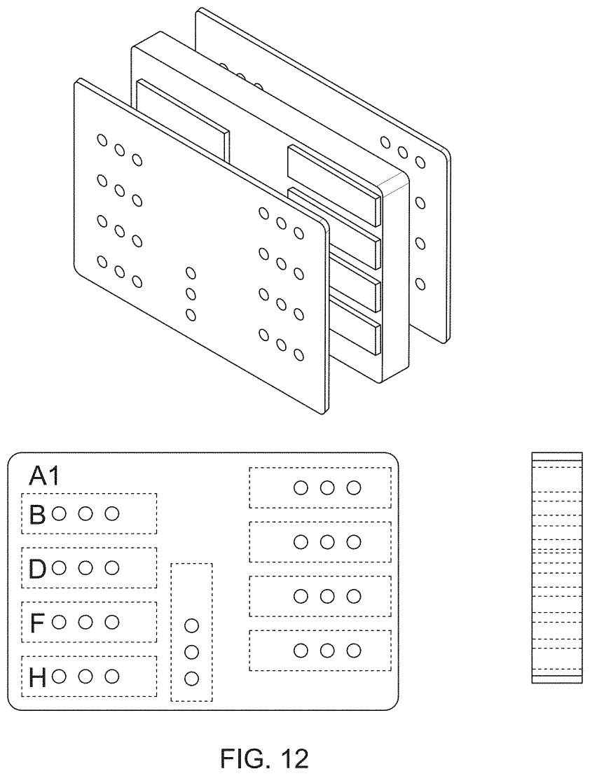

As shown in FIGS. 3 and 6, a QC kit may include the following:

QC Kit includes the following items:
Flight case for containing all items making up the kit(s) with laser etched barcode and placard shown in FIG. 1c (APPENDIX).
Decontamination solution contains Lysol-IC prefer blue color brand packaged in 4 dram glass vials and used for decontaminating the instruments.
Tablet containing spreadsheets and GLHtracker software. Access personalized for the tech(s) granted access for data analysis and reporting abiding to NIST traceability and record tracking.
Digital piston driven syringe pipette (Optional/Recommended) used for generating the “gold” standard and reference curves for conversion of optical density (x-axis) measured on a spectrophotometer to volume (y-axis). Pipettes Good Liquid Handling (GLH) Volume Verification Calibration (VnV Cal) reagents that are a red colored dye solution.
Trough used for manual pipetting dye with digital syringe pipette in generating a standard and reference curve. Hold GLH VnV Cal reagents that are a red colored dye solution.
Reservoir(s)—single well for entire head testing or 12 well for 4, 8, 16 channels.
96 and/or 384 well microtiter plates GLH certified and validated used to contain the reagents measured on the absorbance reader verifying volume delivery and running calibrations.
Reference reagent aqueous, PBS, or DMSO tuned dye mixture entitled Alpha used as the first point on generated reference curve.
Reference reagent aqueous, PBS, or DMSO tuned dye mixture entitled Beta used as the second point on generated reference curve.
Reference reagent aqueous, PBS, or DMSO tuned dye mixture entitled Gamma used as the third point on generated reference curve.
Reference reagent aqueous, PBS, or DMSO tuned dye mixture entitled Omega used as the fourth point on generated reference curve.
Nano Reagent—GLH VnV Cal reagents for nanoliter dispensing range 100 nL-1000 nL
Micro Reagent—GLH VnV Cal reagents for microliter dispensing range 1-5
Bulk Reagent—GLH VnV Cal reagents for bulk liter dispensing range 5μL to 50
Large Reagent—GLH VnV Cal reagents for microliter dispensing range 50 μL to 1200
Environmental data logger wife through the air data gathering of humidity and temperature environmental conditions during testing.
Lab safety glasses and gloves
GLH pen and flashlight for observing instrument operation.
Sharpie pen for labeling plate covers and as needed labware labeling and writing.
Not shown in FIG. 2 (APPENDIX)
   Spreadsheets for data processing downloaded from website post warranty activation.
   Robot Method(s) for operating robots (Automated Liquid Handlers).
   Reader Method(s) for operating spectrophotometer.
   GLHTracker is compliant software for reporting, tracking, analyzing, and data processing. It runs as an application on a tablet, phone, laptop/desktop. It is released as a desktop and cloud based product.
   User Manual and Protocol provides information on the product and what to use the product for.
   Quick Guide provides basic instructions for how to conduct the volume verification and/or calibration(s).
      SOP(s) (Add ons) explains details on how to conduct volume verification with methods and settings for operating instruments and executing the process on specific vendor instrument(s) requested.

FIG. 3 (APPENDIX) shows yet another embodiment of a kit. As shown, the kit includes the following:
VnV Kit—GLH Volume Verification (VnV) Kit® used for testing precision, accuracy, and verifying liquid dispensed by pipetters and Automated Liquid Handlers in the nano, micro, bulk, and large volume range.
Kit includes as shown in the diagram VnV kit:
Consumables: VnV Testing Reagents (Dyes)
   Labware for precision testing and volume verification
   Decontamination Solution
   Software: Data processing Spreadsheets provided
   Spectrophotometer sample method or guidance for a getting started method
   Automated Liquid Handler Pipetting Robot getting started method(s) if supported
   Support: Online Live Chat, Email, limited remote, limited phone, and ticketing support.
   Instructions: a user manual and instructional guide for volume verification and a quick guide is provided.
VNV Kit CONTENTS (The kit may or may not be supplied in a case. And, may include test reagents for precision testing (% CV). Limited software may be provided for analysis and reporting of % CV.)
   Flight case for containing all items making up the kit(s) with laser etched barcode and placard shown in FIG. 3.
   Decontamination solution contains Lysol-IC prefer blue color brand packaged in 4 dram glass vials and used for decontaminating the instruments.
   Reservoir(s)—single well for entire head testing or 12 well for 4, 8, 16 channels. 96 well microtiter plates GLH certified and validated used to contain the reagents measured on the absorbance reader verifying volume delivery and running calibrations.
   Nano Reagent—GLH VnV Cal reagents for nanoliter dispensing range 100 nL-1000 nL
   Micro Reagent—GLH VnV Cal reagents for microliter dispensing range 1-5
   Bulk Reagent—GLH VnV Cal reagents for bulk liter dispensing range 5μL to 50
   Large Reagent—GLH VnV Cal reagents for microliter dispensing range 50 μL to 1200
   GLH pen and flashlight for observing instrument operation.
   Sharpie pen for labeling plate covers and as needed labware labeling and writing.

Not shown in FIG. 3
Spreadsheets for data processing downloaded from website post warranty activation.
Robot Method(s) for operating robots (Automated Liquid Handlers).
Reader Method(s) for operating spectrophotometer.
User Manual and Protocol provides information on the product and what to use the product for.
Quick Guide provides basic instructions for how to conduct the volume verification and/or calibration(s).
GLHTracker (optional add on) is compliant software for reporting, tracking, analyzing, and data processing. It runs as an application on a tablet, phone, laptop/desktop. It is released as a desktop and cloud based product.

In another embodiment, a 384 Upgrade Kit is a variation on the QC and VnV kits to make it suitable for use with 384 well plates. The upgrade kit is only available for upgrading the QC and Service Cal Kits and in one embodiment, may include the following:
384 well plate(s)
384 format spreadsheets
Protocol for the 384 well format for vendor specific robots (Automated Liquid Handlers) and spectrophotometer readers that support 384 well plate reading.

In another embodiment, a DMSO Upgrade Kit is a variation on the QC and VnV kits for use with DMSO based reactions. It includes the same materials as the original kits. However, the reagents are DMSO reagent bases rather than aqueous based. Differences include:
Nano DMSO Reagent
Micro DMSO Reagent
Bulk DMSO Reagent
Large DMSO Reagent
Alpha DMSO
Beta DMSO
Gamma DMSO
Omega DMSO
Decontamination reagent
384 well plate
DMSO Protocol
384 format spreadsheets
Add ons for GLHtracker DMSO analysis
Robot method Liquid class settings

Reagent Resupply Kit Design: An embodiment of a Reagent Resupply Kit contains pillow pack reagents to replaced used consumable reagents from the Service Kit, QC Kit or VnV kit. Reagents have a limited shelf-life and cannot be reused once opened. Resupply Kits contain a quantity of 30 pillow packs. Materials included in the Resupply kit include:
Nano Reagent
Micro Reagent
Bulk Reagent
Large Reagent
96 well plates or 384 well plates

Different kits may be provided to suit various user needs. Kits focus on precision testing and accuracy testing only, Quality Control (includes testing and calibration), Service (includes Quality Control, and serviceability of absorbance readers for Nist traceability). In addition, user needs met are based on volume ranges such as nano, micro, bulk, or large volume kits.

In one embodiment, consumable medical manufactured visible light absorbance dye is stored in pillow packs. Accessory devices that make up the kit enabling it to accomplish volume verification and calibration are also included. (See Table in APPENDIX.)
Example Pillow Pack Designs: Calibration and Volume Verification Reagent Solutions are
Nano 30 mL pillow packs
Micro 30 mL pillow packs
Bulk 30 mL pillow packs
Large 100 mL pillow packs
XLarge 100 mL pillow packs—volumes greater than 200 uLs tested in deepwells

Pillow Pack Reagent Operating Ranges: In one embodiment, pillow pack reagent operating ranges include the following:
Operating range of each pillow pack are listed below for each design.
   Nano: 0.5 μL≤Vol<1.3 μL
   Micro: 1.3 μL≤Vol<4.5 μL
   Bulk: 4.5 μL≤Vol<45 μL
   Large: 45 μL≤Vol<1200 μL
   XLarge: 200 μL≤Vol<2000 μL

Each pillow pack in this embodiment contains a dye base mix, which is an FDA approved dye coloring, proprietarily mixed to make a stable linear single dye based solution. Decontamination solution can be, for example, a Lysol mix with a blue color and resides currently in a 2 dram to 4 dram vial may also be manufactured as a pillow pack. In this embodiment, 3 volume sizes manufactured for pillow packs 15 mL, 30 mL, and 100 mL are provided.

15 mL pillow packs are used for the references. Contents: Alpha, Beta, Gamma, or Omega reference mixtures. Tolerances: Within +/−0.001%

Color of Dye: Red

Art work: Contains barcode that may be scanned with a cell phone app to provide pillow pack product details from a webpage

Print—Product name, lot number and company information is printed on the pillow pack as shown.

Reference consumables are used for generation of a conversion curve from Optical Density (OD) to Volume Dispensed, detailed in the User Manual area below.

In some embodiments, Pillow packs are produced in black and white color. Black pillow packs do not fade after irradiation that is part of the sterilization process. If sterilization is requested it may be provided with the black pillow packs.

Various embodiments of pillow packs are described at length in the APPENDIX.

Generation of a Reference Curve:

Generation of a Reference Curve using the reference α, β, γ, and Ω is shown with reference to FIG. ______ (APPENDIX). As an example, utilizing the Large Dye pillow pack is included below.

Large Dye Standard Curve in Water—96 Well Plate
1. Use a pair of scissors to open the top of a Large Dye pillow pack. Pour the contents into one of the included disposable reagent troughs.
2. Pour 50 mL of distilled water into a second disposable trough.
3. Use a high precision single channel pipette to dispense water then dye across the top row of a clear 96 well plate. 12 wells are filled across the top of the plate. Total well volume is 200 μl in each well. The first 3 wells from left to right (A1-A3) are filled with 150 μl diluent and 50 μl of Large dye.
4. The second 3 wells (A4-A6) are filled with 100 μl of diluent and 100 μl of Large dye.
5. The third 3 wells (A7-A9) are filled with 50 μl of diluent and 150 μl of Large dye.
6. The fourth set of 3 wells (A10-A-12) are filled with 160 μl of diluent and 40 μl of Large dye.
7. Refer to the following diagram to verify that your plate has been constructed correctly:
8. Cover the plates with a plate lids and put the plates on a shaker to shake the plates for 30 seconds at 600 rpm. Most absorbance readers may have a shaker built in with 600 rpm capabilities.
9. Standard curves are read at 450 and 650nm using the same procedure as the Test Plate, but data is pasted into the excel tabs labeled “REF 450” and “REF 630.” Read the test plates with the same wavelengths that were read on the standard curve plate.
   When entering your data into the spreadsheet, make sure that you manually enter the actual values used for each reference point in the red box on the tab labeled “REF OD.” Enter the data like this (APPENDIX). This will generate the standard reference curve in the excel software.

Standard Operating Procedure: An SOP can be provided for each reader and robot explaining how to use the methods for testing and calibration. Also provide details on the settings and liquid classes to help the user validate the system. We provide validation services if they would like us to validate the system or provide a pre-validated solution.

These are some of the processes that may be calculated and performed by our system. For example, there is a volume verification and calibration process. Volume verification is a single these that determines if your channels pass or fail to deliver the desired goal (volume) based on specified threshold criteria from a desired volume goal. The calibration is an iterative process that occurs till channels reach a criteria from a desired goal (volume). A calibration is a set of volume verifications performed from setting adjustments and instrument performance tuning and optimization. The volumes are verified from test runs performed till the system passes on both accuracy and precision.

Blanks can be used as controls to measure the noise level and commonly generated by filling wells of microplates with just diluent and no dye. We have developed a process that is based measuring noise levels at specific wavelengths equivalent to measure blanks at wavelengths characteristic of the dye's chromophore signal.

Blanks per range are unnecessary to generate since the blank signal at 425 nm is equivalent value at 600-650 nm of the noise level of GLH™ dyes. Blanks are treated by applying the noise level read at a wavelength equivalent to that of a blank read at the wavelength that produces a signal characteristic of the dye. Noise levels are subtracted in the data analysis for absorbance signals measured on tests and for the reference reads.

Single Reference Curve covering all volume ranges: Blanks per range are unnecessary to generate since the blank signal at 425 nm is equivalent value at 600-650 nm of the noise level of GLH™ dyes. Blanks are treated by applying the noise level read at a wavelength equivalent to that of a blank read at the wavelength that produces a signal characteristic of the dye. Noise levels are subtracted in the data analysis for absorbance signals measured on tests and for the reference reads.

Spectrophotometry enables rapid multi-channel inspection requiring a standard/reference curve of optical density to volume. References have been manufactured to enable users to rapidly generate a reference curve with tolerances based on the use of a digital syringe or calibrated manual pipette. Creation of reference curves over standard curves proved efficient reduction in human error and effort by 87.5% from 12 dispenses with reference curves (4 reference by 3 repeats covers all ranges) opposed to 96 with standard curve generation (4 diluent+4 test by 3 repeats by 4 ranges). A single reference is constructed from the use of alpha, beta, gamma, and omega reference dyes supplied in pillow packs (currently manufactured in 15 ml pillow packs). The reference curve covers all volume ranges nana, micro, bulk, and large.

Documentation: Each kit comes with user manuals, Standard Operating Procedures (SOPs) and Protocols.

Accessory products included in some kits. These products are exceptional quality and enable optimal results for our reference and calibration products. They include: Digital Positive Displacement Syringe based pipette, Environmental WiFi cloud based datalogger, Tablet and Calibration Plate.

Consumable accessories necessary for testing included with a kit purchase include: 96 microtiter plates and/or 384 microtiter plates. Plates included are selected at the time of the kit purchase.

Rapid Volume Verification Technologies for Various Automated Pipetting and Liquid Handling Instrumentation Use Cases:

Automated liquid handling (ALH) and manual pipetting equipment are essential instruments in life science and chemistry laboratories conducting experiments that demand accurate, reproducible and efficient delivery of results. Proper calibration and optimization of liquid handling equipment (whether automated or manual) is essential for both accuracy and reproducibility. Accuracy and precision of instruments from six manufacturers capable of nanoliter to milliliter dispensing was investigated using methods including gravimetric, single-dye photometry, ratio metric photometry, and quantitation using qPCR. Results are reported detailing which techniques and methods were observed to be most applicable for various volumes. A novel software platform (FIG. 2 bottom) was developed to manage and analyze data results used for cataloging validation of liquid classes, verification of instrumentation methods, regulatory and compliance purposes as well as maintaining a log of instrument service, maintenance, performance, and interfacing with ELIN and LIMS systems.

Automated Liquid Handling (ALH) and manual pipettes are increasingly essential tools in life sciences and chemistry laboratories. These tools are utilized in experimental approaches including assay development, high throughput screening, next generation sequencing, genomics and proteomics, clinical studies, and more. With the growing awareness of the need for reproducibility and inter-lab repeatability of experiments, there is a clear need for rapid and reproducible methods to assess the accuracy, precision and performance of automated liquid handlers. Used to improve the repeatability of volume transfers, ALH must be optimized to achieve accurate results. Specificity, volume range, accuracy, precision, liquid class settings, and environmental parameters can all affect ALH performance.

Good Liquid Handling (GLH™) quality control and volume verification kits (FIG. 1) were developed to take the guesswork out of validation and verification of liquid classes and instrument methods, calibration, and verification of a variety of ALH and manual pipetting systems. To evaluate the performance of GLH™ kits we a) compared to other methodologies and b) used with various ALH instruments and microplate readers that we conducted in a reproducibility study. We report our current results on the accuracy and precision obtained with methods including single dye, dual dye, and gravimetric analysis systems, and discuss which methods were found to be most applicable for various volume ranges. In addition to the application of GLH™ reagents for quality control and volume verification, we demonstrate use of the GLH™ kit and the Artel MVS® to assess functional performance of liquid handlers used in serial dilutions for qPCR assays.

The methods are compatible with liquid handlers equipped with any number of channels, including: 4, 8, 16, 96, or 384. The GLH™ methods involve first constructing a reference curve, using highly accurate and precise manual pipettes for liquid transfers, and then using the ALH instrumentation to transfer defined volumes of diluent and GLH™ or MVS® reagents to a microplate. These methods were developed using the same pipetting techniques and liquid classes as those used in a clinical laboratory. Quality Control (QC) methods test up to four volumes, in triplicate for each channel, on a single microplate for full calibration of a 8 channel system whereas Volume Verification (VnV) methods examine one volume with replicates to fill an entire plate (FIG. 2).

Automated Liquid Handlers. The following instruments were included in the study and used according to each manufacturer's specifications: Tecan Evo 150/200, Agilent Bravo NGS Workstation, Option B, Hamilton® STAR/STARLET, Beckman Coulter FX and FXp Dual Pod, Beckman Coulter Biomek NXp, MPH 96 and Span-8 systems, Perkin Elmer® Janus Span-4, Gilson PIPETMAX, digital syringe, and Microlit™ pipettes. Robots were positionally adjusted and checked to ensure they were within calibration before use in evaluating methods.

Labware. Labware used in these studies included 96 and 384 flat optical bottom black, white, and clear polymer plates available from Nunc, Corning, and Greiner. Reagent reservoirs were obtained from Click Bio or Seahorse (Agilent).

Spectrophotometers. The following plate readers were used according to each manufacturer's specifications: BioTek® Synergy H1 Hybrid Plate Reader, BioTek® Synergy 2 Multi-Mode Reader, Biotek® μQuant™ Reader using GLH™ dyes and MVS® red dyes Ranges A,C, D, with blank (blue) dye, Tecan Infinite 200, and BMG Clariostar®. Instruments were calibrated and ISO certified for NIST traceability.

Spectrophotometers. The following plate readers were used according to each manufacturer's specifications: BioTek® Synergy H1 Hybrid Plate Reader, BioTek® Synergy 2 Multi-Mode Reader, Biotek® μQuant™ Reader using GLH™ dyes and MVS® red dyes Ranges A,C, D, with blank (blue) dye, Tecan Infinite 200, and BMG Clariostar®. Instruments were calibrated and ISO certified for NIST traceability.

Dual Dye Methods. Artel MVS® multichannel verification system (4) was used according to the manufacturer's instructions.

Gravimetry. Gravimetric analysis was carried out using a Hamilton® Liquid Verification Kit (LVK) with a Mettler Toledo balance.

Serial Dilution Assessment for qPCR Setup. The serial dilution performance assessment was conducted using an established automated qPCR preparation method designed on the Agilent Bravo NGS Workstation, Option B. NGS library samples of known concentration were serially diluted to a target dilution factor, then plated with qPCR master mix reagent before executing qPCR (15). Six standards of known concentration were also run to produce the needed standard curve for concentration determination. qPCR reagents were obtained from KAPA Biosystems KK4854 Library Quantification Kit and used according to the manufacturer's instructions. For the spectrophotometric correlation, GLH™ QC Bulk Dye™ was used as a substitute sample during serial dilution preparation and diluted using the same qPCR setup method. Standard GLH™ QC™ volume verification was then performed using the GLH™ QC™ reference curve.

Results and Discussion:

Reference Curve: Spectrophotometry enables rapid multi-channel inspection requiring a standard/reference curve of optical density to volume. (FIG. 2) Reference curves using a Microlitte versus an Evol® XRA showed a 0.02% change in % CV having a minor impact on the % CV overall. Creation of reference curves over standard curves proved efficient reduction in human error and effort by 87.5% from 12 dispenses with reference curves (4 reference by 3 repeats covers all ranges) opposed to 96 with standard curve generation (4 diluent +4 test by 3 repeats by 4 ranges). In addition, blanks per range were unnecessary since the blank signal at 425nm was found an equivalent value at 600-650 nm of the noise level of GLH™ dyes.

Gravimetric, GLH™, and MVS® We evaluated the GLH™ Quality Control™ (QC™) and Volume Verification™ (VnV™) Kits for determining accuracy and precision of ALH instruments and compared the results obtained with GLH™ vs. gravimetric and an MVS® dual dye system. Results obtained with a Hamilton® STAR and BeckmanCoulter Biomek FXp are shown in FIG. 3. GLH™ VnV™ achieved delivery of various volumes between 2 ul and 200 ul accurately and precisely with % CVs ranging from 1% and 4.5%.

It was found in the comparison study, spec systems (GLH QC™ and Artel MVS®) allowed for quick and consistent replicates across a plate vs. gravimetric (LVK) single sample replicate per measurement. Spec systems are able to capture individual measurements per replicate while operating within a plate environment. The aqueous % CV values for both spec systems tested performed similarly across volume spectrum. The GLH™ QC™ kit and associated templates are effective in calibrating aqueous liquid class systems using the same materials as the VnV™ process. The GLH™ products meet Beckman, Tecan, Agilent, Hamilton®, and Gilson® published ranges for Accuracy and Precision and meet requirement for Volume Verification within an accredited laboratory.

The GLH™ QC™ kit can be used to test the dispensing results of automated liquid handlers and calibrate them into performance. Data from pre-and post-calibration of aqueous liquid class on a Hamilton® STAR and Gilson® PIPETMAX are shown in FIG. 4 respectively.

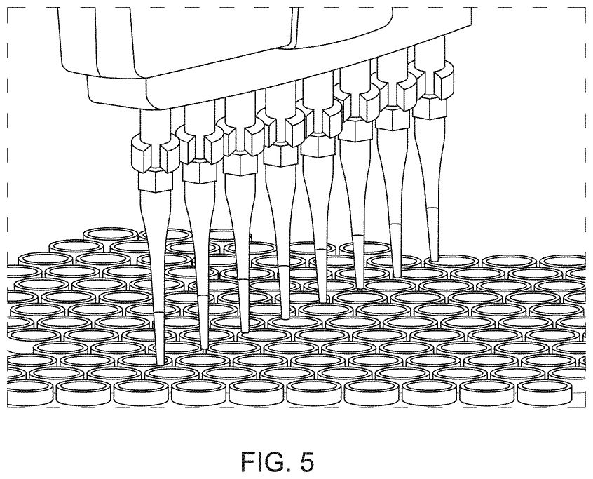

Using a Molecular Devices Spectramax M2e and Formulatrix® Mantis® was found that the GLH™ system achieved delivery of various volumes between 100 nl and 200 μl accurately and precisely with coefficients of variation (% CVs) ranging from 1% to 4.5%.(FIG. 5b) GLH™ was effective in verifying the performance of a 384 channel Tecan ALH MCA384 DiTi 15: <0.5 μL-2.01 μL> in wet contact and a MCA96 (data not shown). Table 1 shows a list of instruments that the GLH™ kits were tested on.

We compared the Artel MVS® and GLH™ to determine the lowest volume their dye systems could detect based on the sensitivity of the reader. According to the pin tool study the MVS® can detect as low as 20 nL (16,17). We observed that the GLH™ single dye method is limited to 15 nL when using the BioTek μQuant™ due to limitations of the spectrophotometer. However above 15 nL GLH™ has a discernable signal that is 16.7% (20-30 nL) above the noise level (FIG. 5a). Experiments with more sensitive readers and other spectrums may help to find actual lower limit of the dye.

Although the results showed a close comparison, gravimetric was most reliable for single channel. GLH™ as a single dye method was best suited for routine volume verification. Both single dye and dual dye were best fit for high channel and at low volume testing. Although dual dye is more costly it is slightly more accurate and precise due to the pathlength independence. Nevertheless the GLH™ System has been successfully incorporated in Clinical, Research, Forensic, Pharmaceutical, and RNA production labs for verifying and validating results during experimentation. Also utilized for maintenance and repair of dispense heads during Site or Factory Acceptance Testing, quick detection for out of calibration events, and in preventative maintenance testing. (data upon request).

DMSO, PBS, and Aqueous Diluents: The GLH™ products work with DMSO and Aqueous solutions reliably, and performs linearly in both QC solutions. Reference concentrations matched 50% serial dilutions calibration curves, meaning the dye is linear in DMSO, distilled water, and PBS. (data not shown). The GLH™ dyes were found to be slightly more linear and stable to Tartrazine and OrangeG in DMSO solution centrifuged at 2000 RPM for 30 seconds with 25 uL well volumes in 384 well on a Tecan MCA384 Diti-15 using a Tecan Safire 2™ reader (13). Using unoptimized liquid classes 0.5 to 2 uls tested had % CVs <2% and % Error 4 to 9% (based on FMP results). Experiments with other diluents are possible.

qPCR Results: Standard use of the GLH QC Kit™ involves characterizing liquid handling reproducibility performance of a given solution independent of other functional factors. While this use is valid for tracing overall liquid handling performance over time, the characterized reproducibility is not explicitly attached to functional performance within an assay or workflow. An expanded use case for the GLH QC Kit™ was evaluated for characterizing serial dilutions of test material (NGS library samples) (12) for use in a quantitative polymerase chain reaction (qPCR) assay on an automated liquid handling platform. GLH QC™ data was correlated with empirical performance resulting from the automated serial dilution preparation. The correlation demonstrates a direct means of measuring serial dilution performance and a means to set serial dilution calibration before empirical testing (FIG. 6).

The GLH™ system includes spreadsheets into which users paste data from the reference curve as well as signal and noise data. Macros built in to the spreadsheets automatically calculate % error, % CV and, in the case of the QC™ method, information required to calibrate the instrumentation. These spreadsheets can be stored in GLH Tracker™, a system to manage workflow, data analysis, and reporting using a desktop and cloud based system (FIG. 2 bottom).

GLH™ single dye method has a viscosity and density close to water. Our results suggest that GLH™ is well suited for qPCR and low volume delivery and that it complements dual dye and gravimetric methods. We found that the dual dye method is suitable for maintaining path length independence and finding unknowns in serial dilutions, whereas the gravimetry is most suitable for single channel instruments and bulk and large volumes. Future studies include determining the effects of accuracy and precision in qPCR preparations using the GLH™ kits, further comparison of results with gravimetric techniques, and a dual dye that mimics an aqueous solution. The results of the reproducibility study demonstrate the GLH™ kits are a cost effective and reliable solution to the instrument verification process.

Validated kits, which include reference standards as well as the ability to test at various volumes, have been manufactured under sterile conditions and proven to provide a low cost and time saving approach to volume verification and calibration workflows. By providing standardized reagents and methodologies, guesswork and labor intensive procedures are removed from the process of optimizing performance of automated pipetting systems. This support of published manufacturer specifications improves data confidence that the instrument is working properly, by letting the user test and calibrate their own systems on demand. In addition, a novel software platform (GLH Tracker™) was developed to manage and analyze data results for regulatory and compliance purposes and inventory instrument service, maintenance, and performance. Users always know the operation level of their instruments reducing any financial impact from erroneous results, service calls, rework, and/or downtime. Adoption of these methodologies can streamline the use of laboratory pipetting systems.

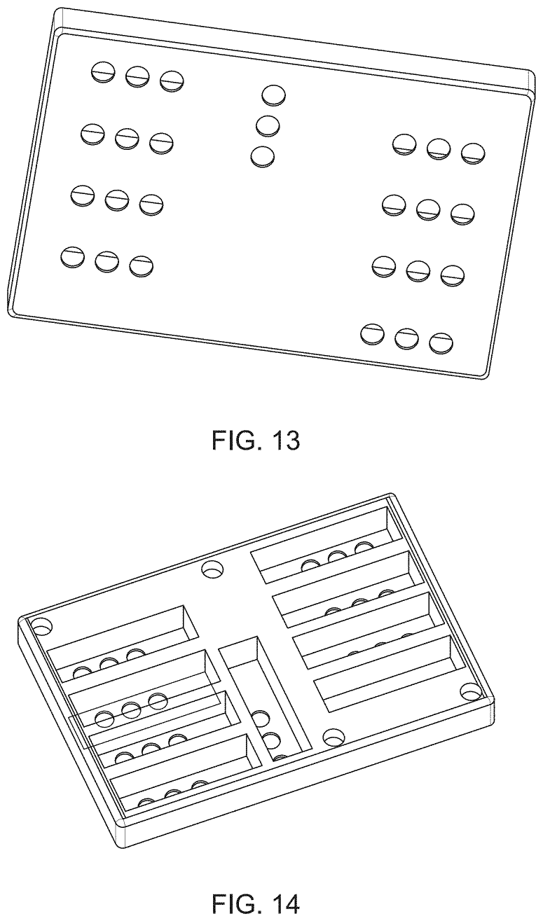

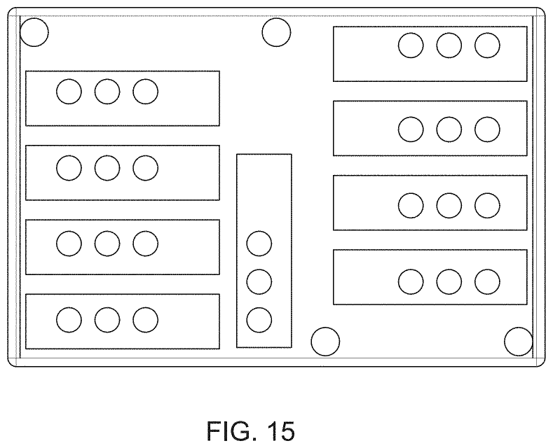

FIGS. 13 through 15 illustrate views of example validation reference plates.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. (canceled)

2. (canceled)

3. (canceled)

4. A process of generating a linear reference curve relating optical density to concentration, pathlength, and volume from reading absorbance from a calibrated spectrophotometer of a fixed path well volume dispensed into a microtiter plate.

5. A reference pipette comprising: a plurality of disposable pipette tips adapted to dispense of reference dyes at fixed pathlength in generation of a reference curve.

6. A process of maintaining pathlength independence during standard curve generation and pathlength corrected sample volumes during performance testing to reflect the actual volume delivered to a pathlength independent standard curve.

7. A method comprising:
generating a reference curve by spectroscopically reading a fixed-volume set of known, variable-concentration derivatives of a single dye;
during testing, dispensing a yet undetermined volume of known-concentration dye into a known volume of diluent which results in a new dye concentration (resultant concentration); and
compare the absorbance of the resultant concentration to the absorbance versus concentration relationship of the earlier generated reference curve to determine the volume of dye and volume dispensed by the liquid handling device.
